(19) United States
(12) Patent Application Publication
(10) Pub. No.: US 2016/0101535 A1
(43) Pub. Date: Apr. 14, 2016

(54) Dual Thickness Food Slicer

(71) Applicant: John L. Schoeman, Mona Vale (AU)

(72) Inventor: John L. Schoeman, Mona Vale (AU)

(21) Appl. No.: 14/509,872

(22) Filed: Oct. 8, 2014

(51) Int. Cl. B26D 3/28

(52) U.S. Cl. CPC B26D 3/283; B26D 2003/286

(57) ABSTRACT

Various embodiments of a food slicer having a removable dual edged blade and blade insert holes that enable two distinctive slice thickness of a food item are provided. In one embodiment, a food slicer is provided, the food slicer comprising: a main body comprising a rear end portion, a front end portion, and a platform extending between the rear end portion and the front end portion; wherein the main body further comprises a first sidewall extending between the rear end portion and the front end portion and a second sidewall extending between the rear end portion and the front end portion; the first side wall including a first blade insert hole and the second sidewall including a second blade insert hole; and a blade comprising a locating lug disposed at a proximal end; wherein the blade extends through the first blade insert hole from a first side of the food slicer to provide a first cutting height and through the second blade insert hole from a second side of the food slicer to provide a second cutting height.

### BACKGROUND

Mandolin type food slicers may be used for slicing vegetables, fruits and other foods. A typical mandolin slicer generally includes a frame with either a single stationary blade to manually slice the food or more than one blade or other specific attachments to obtain a desired cut or shape of the slice. To vary the thickness of the slices many such slicers are equipped with multiple blades or means to adjust the height of the mandolin platform or the relative angle or height of the blade. When slicers are equipped with multiple blades they often require that the blades that are not in use be removed either during operation or before washing the slicer after use. When the slice thickness is varied by means of adjusting the relative angle or height of the blade or the height of a front edge of a cutting platform by using a knob or lever or handle or other types of structures, the user engages in considerable and complicated manipulation of the slicer to obtain the desired thickness of the food slice. Also, such devices having complicated means to adjust thickness of a food slice are bulky and require more storage space. Moreover when a knob or lever that enable a user to adjust the slice thickness fails to function the entire slicer device along with the blade becomes useless.

It is therefore desirable to have a mandolin slicer that avoids complicated maneuvers to vary the thickness of the food slice. It is also desirable to have a compact, easy to store and a simple device with easy means to adjust the relative heights of a single reversible blade that can provide a dependable and regulated thickness of food slices.

### SUMMARY OF THE INVENTION

In one embodiment, a food slicer is provided, the food slicer comprising: a main body comprising a rear end portion, a front end portion, and a platform extending between the rear end portion and the front end portion; wherein the main body further comprises a first sidewall extending between the rear end portion and the front end portion and a second sidewall extending between the rear end portion and the front end portion; the first side wall including a first blade insert hole and the second sidewall include a second blade insert hole; and a blade comprising a locating lug disposed at a proximal end; wherein the blade extends through the first blade insert hole from a first side of the food slicer to provide a first cutting height and through the second blade insert hole from a second side of the food slicer to provide a second cutting height.

In one embodiment, a food slicer kit is provided, the food slicer kit comprising: a food slicer comprising: a main body comprising a rear end portion, a front end portion, and a platform extending between the two; wherein the main body further comprises a first sidewall extending between the rear end portion and the front end portion, and a second sidewall extending between the rear end portion and the front end portion; the first sidewall including a first blade insert hole and the second sidewall including a second blade insert hole; and at least one blade comprising a locating lug disposed at a proximal end; wherein the blade is configured to fit through the first blade insert hole from a first side of the food slicer to provide a first cutting height and through the second blade insert hole from a second side of the food slicer to provide a second cutting height; a hand guard; and an operating manual.

In one embodiment, a method for cutting food slices is provided, the method comprising: placing a food item on a food slicer comprising a main body comprising a rear end portion, a front end portion, and a platform extending between the rear end portion and the front end portion; wherein the main body further comprises a first sidewall extending between the rear end portion and the front end portion and a second sidewall extending between the rear end portion and the front end portion; the first side wall including a first blade insert hole and the second sidewall include a second blade insert hole; and a blade comprising a locating lug disposed at a proximal end; inserting the blade through the first blade insert hole and then the second blade insert hole to provide the first cutting height; holding the food item with a hand guard; placing the food item in contact with a working surface of the food slicer; and sliding the food item repeatedly across the cutting portion of the food slicer until a desired number of slices having a desired thickness are created.

In another embodiment, a method for cutting food slices is provided, the method comprising: placing a food item on a food slicer comprising a main body comprising a rear end portion, a front end portion, and a platform extending between the rear end portion and the front end portion; wherein the main body further comprises a first sidewall extending between the rear end portion and the front end portion and a second sidewall extending between the rear end portion and the front end portion; the first side wall including a first blade insert hole and the second sidewall include a second blade insert hole; and a blade comprising a locating lug disposed at a proximal end; inserting the blade through the second blade insert hole and then the first blade insert hole to provide the second cutting height; holding the food item with a hand guard; placing the food item in contact with a working surface of the food slicer; and sliding the food item repeatedly across the cutting portion of the food slicer until a desired number of slices having a desired thickness are created.

### DESCRIPTION OF THE DRAWINGS

FIG. 1 is a perspective view of an embodiment of a food slicer having a main body and a removable blade. The blade is shown to have a blade handle on one end and a locating lug on the opposing end.

FIG. 2 is a perspective view of the food slicer showing a removable blade partially inserted into the blade insert hole on the left side (as in when a user holds the slicer by the handle) of the slicer.

FIG. 3 is a perspective view of the food slicer showing a removable blade fully inserted into the blade insert hole on the left side of the slicer.

FIG. 4 is a perspective view of the food slicer showing a removable blade partially inserted into the blade insert hole on the right side (as in when a user holds the slicer by the handle) of the slicer.

FIG. 5 is a cross sectional view of the food slicer showing a blade insert hole on the left side of the slicer with a first adjusting height.

FIG. 6 is a cross sectional view of the food slicer showing a blade insert hole on the right side of the slicer with a second adjusting height.

### DETAILED DESCRIPTION

The dual thickness food slicer in accordance with the present disclosure is designed to make food preparation simpler and enjoyable for users. The food slicer disclosed herein can be used to slice any known food item including but not limited to vegetables, fruits, meat and other foods.

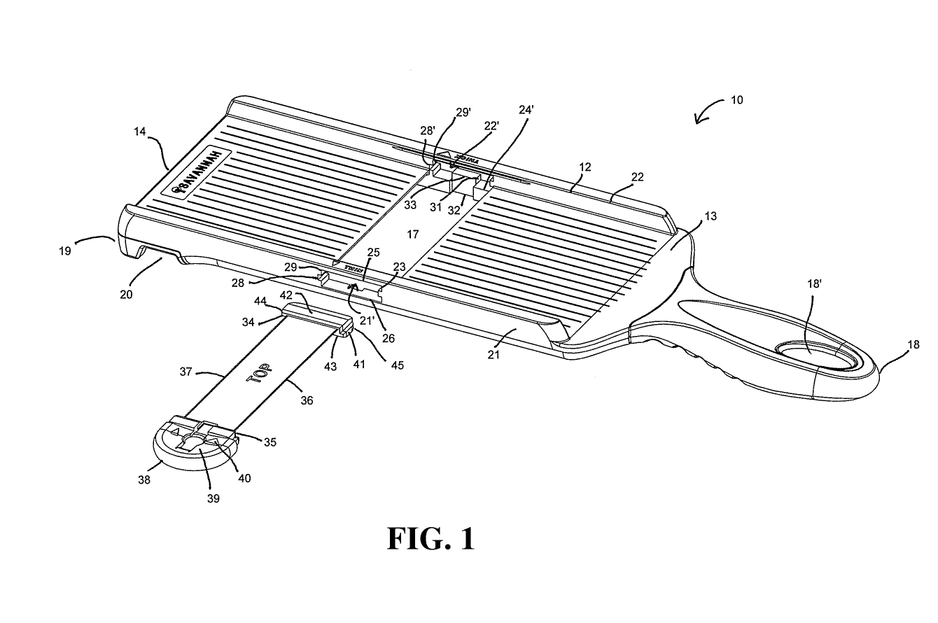

As shown in FIG. 1, in one embodiment, a dual thickness food slicer 10 (hereinafter “food slicer”) includes a main body 12 and a removable blade 16. Removable blade 16 may be a dual edge blade. In one embodiment main body 12 is defined by a rear end portion 13, a front end portion 14, and a platform 15 extending there between. Main body 12 can be made of any known material including but not limited to a polymer, a metal, stainless steel, heavy duty plastic, ceramic, glass, etc. and may be opaque or transparent. In one embodiment, platform 15 is made of heavy duty plastic material that is transparent in order to aid the user in visualizing the slices as the food item is being sliced.

Food slicer 10 may also include features that provide a firm grip of food slicer 10 and prevent it from sliding off of a work surface. Accordingly, food slicer 10 may include an ergonomically designed soft rubberized handle 18 extending from rear end portion 13 of main body 12. Handle 18 may have an aperture 18′ for hanging slicer 10 on a hook for convenient storage. In one embodiment, handle 18 is shaped like a bowling pin, with a small bulbous configuration at a proximal side that curvaceously narrows then widens as it connects to rear end portion 13 of main body 12. The small bulbous proximal side may fit within the palm of the user's hand while the narrowing section with soft grooves or notches may engage the user's fingers.

Rear end portion 13 of main body 12 may also include a foldable stand (not shown) to keep rear end portion 13 elevated while in use. In another embodiment, a short rubberized leg with or without a suction mechanism (not shown) can be employed to prevent slippage of the slicer on the working surface, while non-slip feet 19 may be disposed on or about a bottom surface of front end portion 14 to prevent food slicer 10 from sliding off of the working surface during the slicing operation.

As shown in FIGS. 1-4, the underside of front end portion 14 of main body 12 may have grooves 20 to allow food slicer 10 to rest on most bowls and containers. The grooves 20 may be designed to engage a container's lip such that food slicer 10 does not slip, slide or move as the user is slicing the food. This feature may allow the user to slice off the food items directly into the container. In another embodiment, a separate holder (not shown) may be provided for holding the sliced food products during the slicing operation. In this embodiment food slicer 10 is fixed to the holder during operation.

Referring again to FIG. 1, main body 12 of food slicer 10 may include a first sidewall 21 and a second sidewall 22 extending vertically from either side of the upper surface of platform 15 and vertically between rear end portion 13 and front end portion 14. First and the second sidewalls 21 and 22 of slicer 10 may each have a blade insert holes 21′ and 22′, respectively.

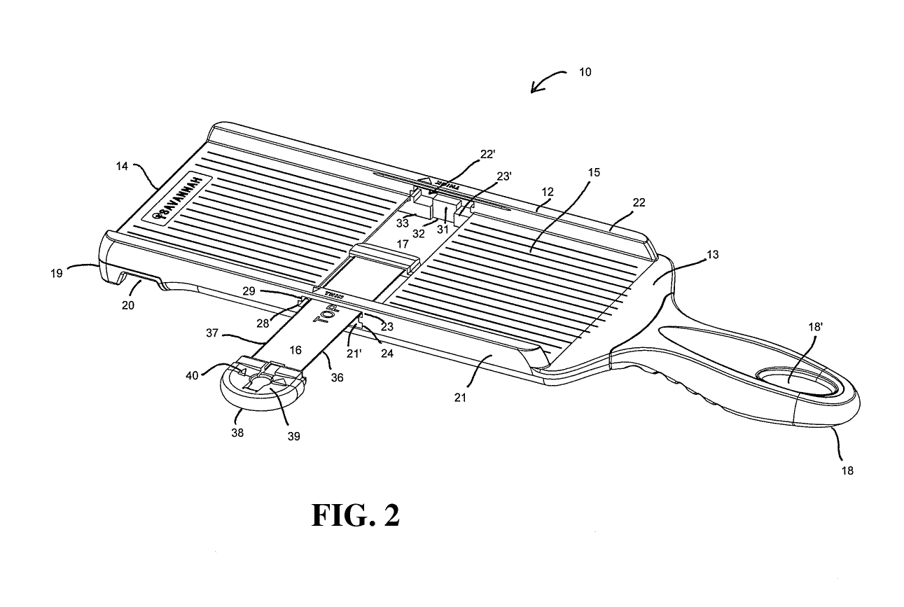

As shown in FIGS. 1-2, blade insert holes 21′ and 22′ may have distinctive shapes. In one embodiment, blade insert hole 21′ is generally rectangular in shape and has two notches 23 and 24 extending laterally at an upper portion 25 and lower portion 26, respectively, of a first side of the first blade insert hole 21′. First blade insert hole 21′ may have one notch 28 extending laterally from a mid-section 29 of a second side of hole 21′. Second blade insert hole 22′ may have a similar shape to that of 21′, except that it includes a protrusion 31 extending upward from a central portion 32 of a bottom surface 33 of second blade insert hole 22′.

Food slicer 10 may include a dual edged removable blade 16. Blade 16 may be generally rectangular in shape, with a proximal end 34 and a distal end 35. The edges 36 and 37 of the blade 16 may be serrated. Edges 36 and 37 may be non-serrated. Edges 36 and 37 may be beveled to allow blade 16 to cut a food item as it is pushed away from the user when the blade inserted into food slicer 10 through either first side wall 21 or second side wall 22. The cutting portion of blade 16 may be formed of a metal, however any suitable material for cutting edge may be used. It should be noted that blade 16 may be a dual edge blade. The dual edged design of blade 16 may allow a user to slice food in both directions as the food is moved back and forth across blade 16 during a typical slicing operation. This dual edged feature may improve the efficiency of slicing a food item with the slicer disclosed herein by reducing the time required to slice a food item. A blade handle 38 may be disposed on distal end 35 of blade 16. Blade handle 38 may include a depression 39 formed thereon to facilitate gripping blade 16 during its insertion and removal from blade insert holes 21′ and 22′. Visual markers 40 may also be included in blade handle 38 to help the user insert blade 16 in the right orientation into blade insert hole 21′ or 22′.

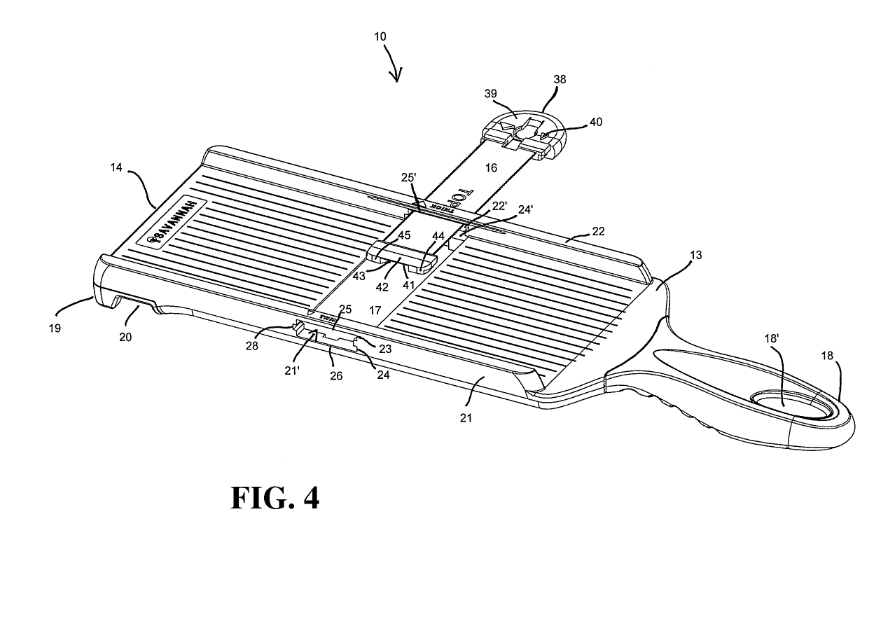

Blade 16 may include a locating lug 41 disposed on the proximal end 34 of blade 16. As shown in FIGS. 1 and 4, locating lug 41 is generally rectangular in shape and is designed to fit within first blade insert hole 21′ at a first cutting height and second blade insert hole 22′ at a second cutting height. As shown in FIG. 1, in one embodiment, locating lug 41 has an upper portion 42 and lower portion 43, with blade 16 disposed there between. Upper portion 42 of locating lug 41 includes a first protrusion 44 extending laterally from upper portion 42 along a first side of locating lug 41 and a second protrusion 45 extending laterally from lower portion 43 along a second side of the lug 41.

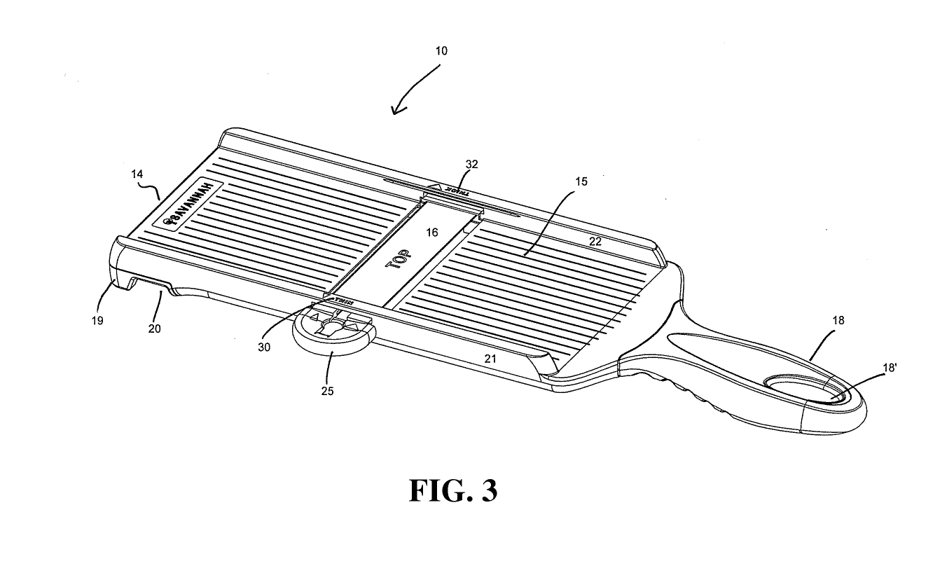

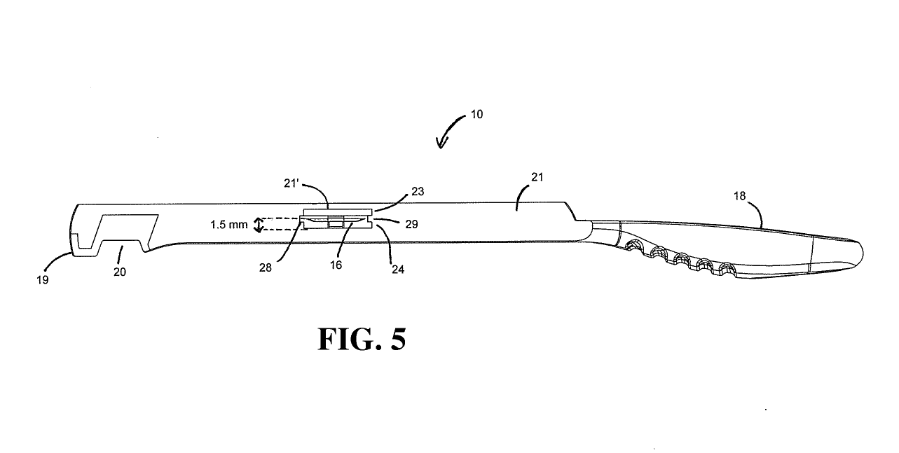

When blade 16 is inserted through blade insert hole 21′ from the left side of the food slicer 10, protrusion 45 extending from lower portion 43 of locating lug 41 corresponds to notch 24 extending from lower portion 26 of first blade insert hole 21′ and protrusion 44 extending from upper portion 42 of locating lug 41 corresponds to notch 28 extending from mid-portion 29 of first blade insert hole 21′. In this configuration, locating lug 41 fits through first blade insert hole 21′, and extends across food slicer 10, covering a traverse opening 17 in the central portion of platform 15, as shown in FIG. 2. Referring now to FIG. 3, locating lug 41 mates with corresponding notches 23′ and 28′ in second blade insert hole 22′, locking blade 16 in place. As shown in FIG. 5, the placement of blade 16 within blade insert hole 21′ on the left sidewall 21 of food slicer 10 may allow for a cutting thickness, between the top of beveled blade edges 36 and 37 and the top of platform 15, of about 1.5 mm. The cutting thickness may be any of a variety of thicknesses ranging between about 0.5 mm to about 5.0 mm. The cutting thickness may be less than about 0.5 mm or greater than about 5.0 mm.

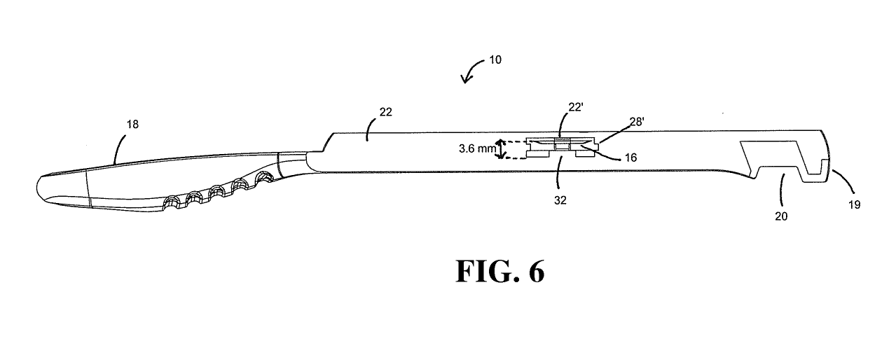

However, as shown in FIG. 4, when blade 16 is inserted from the right side of food slicer 10, protrusion 44 extending from upper portion 42 of locating lug 41 may now correspond to notch 24′ extending from upper portion 25′ of blade insert hole 22′, protrusion 45 extending from lower portion 43 of locating lug 41 may correspond to notch 28′ extending from mid-portion 29′ of blade insert hole 22′, and bottom of locating lug 41 may fit over protrusion 31 extending from bottom surface 33 of blade insert hole 22′. As can be best seen in FIG. 6, the placement of blade 16 within blade insert hole 22′ on the right side of food slicer 10 may allow for a cutting thickness, between the top of beveled blade edges 36 and 37 and the top of platform 15, of about 3.6 mm. The cutting thickness may be any of a variety of thicknesses ranging between about 0.5 mm to about 5.0 mm. The cutting thickness may be less than about 0.5 mm or greater than about 5.0 mm. It should be appreciated that the shape of blade insert holes 21′ and 22′ and locating lug 41 may be modified to create different slicing thicknesses or to include different notch and protrusion configurations, so long as locating lug 41 is configured to fit within each corresponding hole from opposite sides of food slicer 10, without requiring the user to change the hand holding handle 18, without having to flip blade 16 upside down, and while still providing two different slice thicknesses.

To further secure blade 16 firmly on to food slicer 10, a locking mechanism (not shown) may be disposed on blade handle 38. This locking mechanism in some embodiments can include a hook portion (not shown) on blade handle 38 that engages a portion of the insert hole on the insert side. For instance, with reference to FIG. 2, when blade 16 is fully inserted into blade insert hole 21′ the user may press down on a push button (not shown) present on blade handle 38 to initiate the locking mechanism. In some embodiments, the hook, which may form a part of the locking mechanism, may then engage a portion of insert hole 21′ thus locking blade 16 on to food slicer 10. An audible sound, such as a “click,” may accompany the locking mode and indicate to the user that blade 16 is firmly secured to food slicer 10. When the user decides to remove blade 16, he/she may again press the push button down to unlock and release the hook so that blade 16 can be retracted fully from food slicer 10. Additional mechanisms for locking blade 16 in its position are possible including but not limited to latches or the like.

In another embodiment, food slicer 10 can be one component of a food slicer kit. In this embodiment, the kit may comprise food slicer 10, a hand guard (not shown), an instruction manual, and additional blade designs that are designed to fit in the blade insert holes present on the sidewalls of food slicer 10 and which provide various cut to the slices. The different cuts of the food may include but not limited to straight cuts, waffle cuts, strips, julienne slices, etc.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

What is claimed is:

1. A food slicer comprising:
a main body comprising a rear end portion, a front end portion, and a platform extending between the rear end portion and the front end portion; wherein the main body further comprises a first sidewall extending between the rear end portion and the front end portion and a second sidewall extending between the rear end portion and the front end portion; the first side wall including a first blade insert hole and the second sidewall including a second blade insert hole; and
a blade comprising a locating lug disposed at a proximal end; wherein the blade extends through the first blade insert hole from a first side of the food slicer to provide a first cutting height and through the second blade insert hole from a second side of the food slicer to provide a second cutting height.

2. The food slicer of claim 1, wherein the platform includes a transverse opening, and wherein the blade fits within the transverse opening.

3. The food slicer of claim 1, wherein the main body further comprises a soft rubberized handle disposed at the rear end portion.

4. The food slicer of claim 1, wherein the main body further comprises at least one non-slip foot extending from an underside of the front end portion.

5. The food slicer of claim 1, wherein:
the first blade insert hole is generally rectangular in shape and includes a first notch extending from an upper portion of the first blade insert hole along a first side, a second notch extending from a bottom portion of the first blade insert hole along a first side, and a third notch extending from a mid-portion of the first blade insert hole along a second side;
the second blade hole is generally rectangular in shape and includes a first notch extending from a mid-portion of the second blade insert hole along a first side, a second notch extending from an upper portion of the second blade insert hole along a second side, and a third notch extending from a bottom portion of the second blade insert hole along the second side; and
the locating lug comprising a first protrusion extending from a lower portion along a first side and a second protrusion extending from an upper portion along a second side.

6. The food slicer of claim 1, wherein the blade includes a first beveled edge and a second beveled edge.

7. The food slicer of claim 6, wherein at least one of the first beveled edge and the second beveled edge is serrated.

8. The food slicer of claim 1, wherein the blade is made of a metallic material.

9. The food slicer of claim 1, wherein the main body comprises a transparent material.

10. The food slicer of claim 1, wherein the blade further comprises a blade handle disposed at a distal end of the blade.

11. A food slicer kit comprising:
a food slicer comprising:
a main body comprising a rear end portion, a front end portion, and a platform extending between the two; wherein the main body further comprises a first sidewall extending between the rear end portion and the front end portion, and a second sidewall extending between the rear end portion and the front end portion; the first sidewall including a first blade insert hole and the second sidewall including a second blade insert hole; and
at least one blade comprising a locating lug disposed at a proximal end;
wherein the blade is configured to fit through the first blade insert hole from a first side of the food slicer to provide a first cutting height and through the second blade insert hole from a second side of the food slicer to provide a second cutting height;
a hand guard; and
an operating manual.

12. The kit of claim 11, wherein the kit comprises at least two blades.

13. The kit of claim 11, wherein:
the first blade insert hole is generally rectangular in shape and includes a first notch extending from an upper portion of the first blade insert hold along a first side, a second notch extending from a bottom portion of the first blade insert hole along a first side, and a third notch extending from a mid-portion of the first blade insert hole along a second side;
the second blade hole is generally rectangular in shape and includes a first notch extending from a mid-portion of the second blade insert hole along a first side, a second notch extending from an upper portion of the second blade insert hole along a second side, and a third notch extending from a bottom portion of the second blade insert hole along the second side; and
the locating lug of the blade comprises a first protrusion extending from a lower portion along a first side and a second protrusion extending from an upper portion along a second side.

14. The kit of claim 11, wherein the blade includes a first beveled edge and a second beveled edge.

15. The kit of claim 14, wherein at least one of the first beveled edge and the second beveled edge is serrated.

16. The kit of claim 11, wherein the blade is made of a metallic material.

17. The kit of claim 11, wherein the main body of the food slicer comprises a transparent material.

18. The kit of claim 11, wherein the blade further comprises a blade handle disposed at a distal end of the blade.

19. A method for cutting food slices, comprising:
placing a food item on a food slicer comprising: a main body comprising a rear end portion, a front end portion, and a platform extending between the rear end portion and the front end portion; wherein the main body further comprises a first sidewall extending between the rear end portion and the front end portion and a second sidewall extending between the rear end portion and the front end portion; the first side wall including a first blade insert hole and the second sidewall including a second blade insert hole; and a blade comprising a locating lug disposed at a proximal end;
inserting the blade through the first blade insert hole and then the second blade insert hole to provide the first cutting height;
holding a food item with a hand guard;
placing the food item in contact with a working surface of the food slicer; and
sliding the food item repeatedly across the cutting portion of the food slicer until a desired number of slices having a desired thickness are created.

20. A method for cutting food slices, comprising:
placing a food item on a food slicer comprising: a main body comprising a rear end portion, a front end portion, and a platform extending between the rear end portion and the front end portion; wherein the main body further comprises a first sidewall extending between the rear end portion and the front end portion and a second sidewall extending between the rear end portion and the front end portion; the first side wall including a first blade insert hole and the second sidewall including a second blade insert hole; and a blade comprising a locating lug disposed at a proximal end;
inserting the blade through the second blade insert hole and then the first blade insert hole to provide the second cutting height;
holding a food item with a hand guard;
placing the food item in contact with a working surface of the food slicer; and
sliding the food item repeatedly across the cutting portion of the food slicer until a desired number of slices having a desired thickness are created.
